(19) United States
(12) Patent Application Publication
(10) Pub. No.: US 2008/0213665 A1
(43) Pub. Date: Sep. 4, 2008

(54) NONAQUEOUS ELECTROLYTE SECONDARY BATTERY

(75) Inventors: Nobumichi NISHIDA, Osaka (JP); Satoshi YAMAMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/039,805

(22) Filed: Feb. 29, 2008

(30) Foreign Application Priority Data
Mar. 1, 2007 (JP) 2007-050887

(51) Int. Cl. H01M 4/52; H01M 4/40; H01M 4/46; H01M 4/50

(52) U.S. Cl. 429/223; 429/231.95; 429/224; 429/231.6

(57) ABSTRACT

A positive electrode active material of a nonaqueous electrolyte secondary battery according to an embodiment of the invention includes lithium cobalt compound oxide in which at least zirconium and magnesium are added, and lithium nickel manganese compound oxide having a layered structure. The lithium cobalt compound oxide contains at least two types of zirconium- and magnesium-added lithium cobalt compound oxides having zirconium added amounts different from each other. The charging potential of the positive electrode active material is more than 4.3 V and 4.6 V or less versus lithium. With such a constitution, a nonaqueous electrolyte secondary battery using a plurality of positive electrode active materials having different physical properties which not only is capable of being charged at a high charging voltage of more than 4.3 V and 4.6 V or less versus lithium, but also has excellent charging/discharging cycle property and excellent charged storage properties without lowering the battery capacity.

### BACKGROUND

1. Technical Field

The present invention relates to a nonaqueous electrolyte secondary battery. Particularly, the present invention relates to a nonaqueous electrolyte secondary battery using a plurality of positive electrode active materials having different physical properties, capable of being charged at a high charging voltage such as more than 4.3 V and 4.6 V or less versus lithium of an electric potential of a positive electrode active material, and having excellent charging/discharging cycle property and excellent charged storage properties without lowering the battery capacity.

2. Related Art

Here, in an instrument in which such type of nonaqueous electrolyte secondary battery is used, since a space in which the battery is held is prismatic (plane box-shaped) in many cases, a prismatic nonaqueous electrolyte secondary battery produced by holding a power generation element is held in an outer packing can is frequently used. The constitution of such a prismatic nonaqueous electrolyte secondary battery will now be described with reference to the drawings.

FIG. 1 is a perspective view showing a related-art prismatic nonaqueous electrolyte secondary battery by sectioning the battery perpendicularly. This nonaqueous electrolyte secondary battery 10 is produced by holding a plate wound electrode body 14 produced by winding a negative electrode 11, a separator 13 and a positive electrode 12 which are laminated in this order, in the inside of a prismatic battery outer packaging can 15, and by sealing the battery outer packaging can 15 with an opening-sealing plate 16. The wound electrode body 14 is wound so that for example, the negative electrode 11 is positioned in the outermost periphery and exposed. The exposed negative electrode 11 in the outermost periphery is directly contacted with the inside of the battery outer packaging can 15 serving also as a negative electrode terminal and is electrically connected. Further, the positive electrode 12 is formed in the center of the opening-sealing plate 16 and is electrically connected to a positive electrode terminal 18 provided through an insulator 17, through a power collecting body 19.

Further, since the outer packaging can 15 is electrically connected with the negative electrode 11, in order to prevent the short circuit of the positive electrode 12 with the battery outer packaging can 15, an insulating spacer 20 is inserted between the upper terminal of the wound electrode body 14 and the opening-sealing plate 16 so that the positive electrode 12 and the battery outer packaging can 15 are in an electrically insulated state to each other. The positions of the negative electrode 11 and the positive electrode 12 are sometimes exchanged with each other. This prismatic nonaqueous electrolyte secondary battery is produced by inserting the wound electrode body 14 into the battery outer packaging can 15; by laser-welding the opening-sealing plate 16 to an opening of the battery outer packaging can 15; by pouring a nonaqueous electrolyte liquid through an electrolyte liquid pouring pore 21; and by sealing the electrolyte liquid pouring pore 21. By such a prismatic nonaqueous electrolyte secondary battery, not only is wasted space during the use thereof small, but also the excellent advantageous effects of high battery performance and reliability of the battery are exhibited.

As a negative electrode active material used in the nonaqueous electrolyte secondary battery, carbonaceous materials such as graphite and an amorphous carbon are widely used, since carbonaceous materials have such excellent properties such as high safety because dendrites do not grow therein while they have a discharge potential comparable to that of lithium metal or lithium alloy; excellent initial efficiency; advantageous potential flatness; and high density.

Further, as a nonaqueous solvent of a nonaqueous electrolyte liquid, carbonates, lactones, ethers and esters are used individually or in combination of two or more thereof. Among them, particularly carbonates having a large dielectric constant and having large ion conductivity thus the nonaqueous electrolyte liquid thereof are frequently used.

On the other hand, as a positive electrode active material, lithium-transition metal compound oxide such as lithium cobalt oxide (LiCoO₂), lithium nickel oxide (LiNiO₂, lithium manganese oxide (LiMnO₂), spinel-type lithium manganese oxide (LiMn₂O₄) and lithium iron oxide (LiFeO₂) is used, because it is known that by using such a positive electrode in combination with a negative electrode composed of a carbon material, a 4V-class nonaqueous secondary battery having a high energy density can be obtained. Among them, particularly because of various battery properties more excellent than those of other materials, lithium cobalt oxide and different metal elements-added lithium cobalt oxide are frequently used. However, since not only is cobalt expensive, but also the existing amount of cobalt as a resource is small, for continued use of lithium cobalt oxide as a positive electrode active material of the nonaqueous electrolyte secondary battery, it is desired to make the nonaqueous electrolyte secondary battery have even higher performance and longer life.

For enhancing further the performance of such a nonaqueous electrolyte secondary battery, it is an essential task to enlarge the capacity and energy density of the battery and improve the safety of the battery. As a method for enlarging the capacity of the battery, enlarging the density of an electrode material, making a power collector and a separator to be a thin film and enlarging the charging voltage of the battery voltage, are generally known. Further, enlarging the charging voltage of the battery voltage is a useful technology as a method capable of realizing the enlarging of the capacity without changing the constitution of the battery and is an essential technology for enlarging the capacity and the energy density.

By using the lithium-containing transition metal oxide such as lithium cobalt oxide as a positive electrode active material and by combining the positive electrode with a negative electrode active material of a carbon material such as graphite, the charging voltage is generally 4.1 to 4.2 V (the electric potential of the positive electrode active material is 4.2 to 4.3 V versus lithium). Under such a charging condition, the capacity of the positive electrode active material is utilized in only 50 to 60% relative to a theoretical capacity. Therefore, when the charging voltage can be enlarged more, the capacity of the positive electrode can be utilized in 70% or more relative to the theoretical capacity and enlarging the capacity and energy density of the battery becomes capable.

For example, JP-A-2005-85635 discloses an invention of a nonaqueous electrolyte secondary battery capable of achieving advantageous charging/discharging cycle property even when the battery is charged at a high voltage such as 4.3 to 4.4 V versus lithium by using a positive electrode active material in which a compound containing zirconium is attached to the surface of lithium cobalt oxide particles.

Further, JP-A-2005-317499 discloses an invention of a nonaqueous electrolyte secondary battery using a mixture of lithium cobalt oxide and layer-shaped lithium nickel cobalt manganese oxide to which a different metal element is added as a positive electrode active material, and capable of being stably charged at a high charging voltage. This positive electrode active material is produced so that by adding different metal elements of at least Zr, Mg to lithium cobalt oxide, the structural stability thereof at a high voltage is improved and further, by incorporating layer-shaped lithium nickel cobalt manganese oxide having high thermal stability at a high voltage, the safety is secured. By using a combination of a positive electrode using the above positive electrode active material and a negative electrode having a negative electrode active material composed of a carbon material, a nonaqueous electrolyte secondary battery capable of achieving advantageous cycle property and advantageous thermal stability even when the charging voltage is a high voltage such as 4.3 V or more (the positive electrode electric potential is 4.4 V or more versus lithium), has been obtained.

As described above, various improvements for enhancing the charging voltage of the nonaqueous electrolyte secondary battery containing lithium cobalt oxide as a positive electrode active material and enlarging the capacity and the energy density of the battery have been performed. However, when the state of charging of the positive electrode active material is deepened by further enhancing the charging potential of the nonaqueous electrolyte secondary battery, a decomposition of the electrolyte liquid on the surface of the positive electrode active material and a structural deterioration of the positive electrode active material itself are likely to be caused. Such a decomposition of the electrolyte liquid and a structural deterioration of the positive electrode active material is enlarged according to an increase in the charging voltage, so that it was difficult to provide a nonaqueous electrolyte secondary battery having a high capacity in which the same cycle property and charged storage properties as those of a related-art nonaqueous electrolyte secondary battery are maintained.

Here, in related art, for suppressing a reductive decomposition of an organic solvent, various compounds are added to a nonaqueous electrolyte and for preventing a direct reaction of a negative electrode active material with an organic solvent, a technique for forming a negative electrode surface coating (hereinafter, referred to as the “solid electrolyte interface (SEI) surface coating”), which is also referred to as a passivated layer, is known. For example, JP-A-8-45545 discloses an invention of a method including: adding at least one compound selected from the group consisting of vinylene carbonate (VC) and a derivative thereof into a nonaqueous electrolyte of a nonaqueous secondary battery; forming an SEI surface coating on a negative electrode active material by causing the above-noted additive to reductively decompose itself on a negative electrode surface before the insertion of lithium into a negative electrode by a first charging; and causing the SEI surface coating to function as a barrier for preventing the insertion of solvent molecules surrounding lithium ions.

The invention disclosed in the above JP-A-8-45545 could exhibit a predetermined effect in a related-art nonaqueous electrolyte secondary battery using a positive electrode active material charged at a charging voltage of 4.3 V or less versus lithium. However, in a nonaqueous electrolyte secondary battery using a positive electrode active material charged at a high voltage of 4.3 V or more versus lithium higher than that in a related-art nonaqueous electrolyte secondary battery, inversely in the side of the positive electrode, these components are decomposed, so that a stable SEI surface coating could not be formed. Further, disadvantage was caused wherein during the charging and discharging, an SEI surface coating was degraded and the cycle property was impaired.

### SUMMARY

The present inventors have made extensive and intensive studies toward solving the above problems accompanying the related art. As a result, it has been found that by using as lithium cobalt oxide to which different metal elements of at least Zr and Mg are added in a positive electrode active material, two types of components having Zr added amounts different from each other, the deterioration of the SEI surface coating can be suppressed. Based on these findings, the present invention has been completed.

In other words, an advantage of some aspects of the invention is to provide a nonaqueous electrolyte secondary battery using a plurality of positive electrode active materials having different physical properties, capable of being charged at a high charging voltage such as more than 4.3 V and 4.6 V or less versus lithium of an electric potential of the positive electrode active material, and having excellent charging/discharging cycle property and excellent charged storage properties without lowering the battery capacity.

A nonaqueous electrolyte secondary battery according to an aspect of the invention is a nonaqueous electrolyte secondary battery including a positive electrode having a positive electrode active material, a negative electrode having a negative electrode active material, and a nonaqueous electrolyte having a nonaqueous solvent and an electrolyte salt, in which the positive electrode active material contains lithium cobalt compound oxide in which at least zirconium and magnesium are added, and lithium nickel manganese compound oxide having a layered structure; the lithium cobalt compound oxide contains at least a mixture of lithium cobalt compound oxide A in which 0.001 to 0.05 mol % of zirconium is added and lithium cobalt compound oxide B in which 0.1 to 1 mol % of zirconium is added; the content of lithium cobalt compound oxide A is 10 to 30% in a mass ratio based on the total mass of the positive electrode active material; the magnesium added amount in the lithium cobalt compound oxides A and B is respectively 0.01 to 3 mol %; the content of lithium manganese nickel compound oxide having a layered structure is 10 to 30% in a mass ratio based on the total mass of the positive electrode active material; and the charging potential of the positive electrode active material is more than 4.3 V and 4.6 V or less versus lithium.

In the nonaqueous electrolyte secondary battery of the present aspect of the invention, it is necessary that the positive electrode active material contains a mixture of lithium cobalt compound oxide in which at least zirconium and magnesium are added, and lithium manganese nickel compound oxide having a layered structure. By adding zirconium and magnesium to lithium cobalt compound oxide, the structural stability of the battery in a high voltage state is improved and further, by mixing lithium manganese nickel compound oxide having a layered structure and having high thermal stability in a high voltage state, with the lithium cobalt compound oxide, the safety of the battery can be secured.

Further, in the nonaqueous electrolyte secondary battery of the present aspect of the invention, it is necessary that lithium cobalt compound oxide is a mixture of lithium cobalt compound oxide A in which 0.001 to 0.05 mol % of zirconium is added and lithium cobalt compound oxide B in which 0.1 to 1 mol % of zirconium is added, and the mass ratio of lithium cobalt compound oxide A is 10 to 30% based on the mass of the total positive electrode active material.

It is not preferred that the added amount of zirconium in lithium cobalt compound oxide A is less than 0.001 mol %, since the charged storage properties are impaired, and that the added amount of zirconium is more than 0.05 mol %, since the charging/discharging cycle property is impaired. Further, it is also not preferred that the added amount of zirconium in lithium cobalt compound oxide B is less than 0.1 mol %, since the charged storage properties at higher temperatures are impaired and that the added amount of zirconium is more than 1 mol %, since not only is the charging/discharging cycle property impaired, but also the effect by incorporating lithium cobalt compound oxide A in the positive electrode active material cannot be confirmed.

Further, in the nonaqueous electrolyte secondary battery of the present aspect of the invention, it is necessary that the mass ratio of lithium cobalt compound oxide A is 10 to 30% based on the mass of the total positive electrode active material. When the content of lithium cobalt compound oxide A is less than 10% in the mass ratio based on the mass of the total positive electrode active material, the charging/discharging cycle property is impaired and when the content of lithium cobalt compound oxide A is more than 30% in the mass ratio based on the mass of the total positive electrode active material, the charged storage properties are impaired.

Further, in the nonaqueous electrolyte secondary battery of the present aspect of the invention, it is necessary that the added amount of magnesium in lithium cobalt compound oxides A and B is 0.01 to 3 mol % respectively.

When the added amount of magnesium in lithium cobalt compound oxides A and B is less than 0.01 mol %, though the initial capacity is large, both the charging/discharging cycle property and the charged storage properties are impaired, which is not preferred. On the other hand, when the added amount of magnesium in lithium cobalt compound oxides A and B is more than 3 mol %, though both the charging/discharging cycle property and the charged storage properties are advantageous, the initial capacity is lowered, which is not preferred.

Further, in the nonaqueous electrolyte secondary battery of the present aspect of the invention, it is necessary that the content of lithium manganese nickel compound oxide having a layered structure is 10 to 30% in the mass ratio based on the mass of the total positive electrode active material.

When the content of lithium manganese nickel compound oxide having a layered structure is less than 10% in the mass ratio based on the mass of the total positive electrode active material, though the initial capacity and the charged storage properties are advantageous, the charging/discharging cycle property is impaired, which is not preferred. On the other hand, when the content of lithium manganese nickel compound oxide having a layered structure is more than 30% in the mass ratio based on the mass of the total positive electrode active material, though the charging/discharging cycle property and the charged storage properties are advantageous, the initial capacity is lowered, which is not preferred.

With the nonaqueous electrolyte secondary battery of the present aspect of the invention, by containing the above-described constitution, a nonaqueous electrolyte secondary battery capable of being charged at a high charging voltage such as more than 4.3 V and 4.6 V or less versus lithium of the electric potential of the positive electrode active material and having excellent cycle property and excellent charged storage properties, can be obtained. Further, preferably, when the nonaqueous electrolyte secondary battery is charged at a high charging voltage such as 4.4 V or more and 4.6 V or less versus lithium of the electric potential of the positive electrode active material, the action effect of the present aspect of the invention becomes much more remarkable.

Further, in the nonaqueous electrolyte secondary battery of the present aspect of the invention, the lithium manganese nickel compound oxide having a layered structure is a compound represented by a formula: LiₐNiₛMnₜCoᵤO₂ (where 0<a≦1.2, 0<s≦0.5, 0<t≦0.5, 0≦u, s+t+u=1, 0.95≦s/t≦1.05).

This lithium manganese nickel compound oxide having a layered structure in the above range of the composition becomes have extremely excellent thermal stability even in a high voltage state.

According to some aspects of the invention, as described more specifically hereinafter referring to various Embodiments and Comparative Examples, a nonaqueous electrolyte secondary battery in which the charging/discharging cycle property and the charged storage properties are remarkably improved without lowering the battery capacity, can be obtained.

### BRIEF DESCRIPTION OF THE DRAWINGS

FIG. 1 is a perspective view showing a prismatic nonaqueous electrolyte secondary battery by sectioning the battery perpendicularly.

### DESCRIPTION OF EXEMPLARY EMBODIMENTS

Hereinafter, exemplary embodiments for carrying out the invention are described more specifically referring to various Embodiments and Comparative Examples. However, the following Embodiments illustrate only examples of the nonaqueous electrolyte secondary batteries for embodying the technical concept of the invention and it is not intended that the invention is specified to these Embodiments, so that the invention can be equally applied also to various modifications without departing from the technical concept shown in the appended claims.

### First to Eleventh Embodiments

### First to Tenth Comparative Examples

First, specific production methods of the nonaqueous electrolyte secondary batteries used in the First to Eleventh Embodiments and First to Tenth Comparative Examples are described.

### Preparation of Positive Electrode Active Material

Different metal elements-added lithium cobalt compound oxide was prepared as follows. With respect to the starting material, as a lithium source, lithium carbonate (Li₂CO₃) was used and as a cobalt source, different metal elements-added tricobalt tetraoxide (CO₃O₄) was used. Among them, as different metal elements-added tricobalt tetraoxide, used was different metal elements-added cobalt carbonate produced by a method including: adding an acid aqueous solution containing respectively predetermined concentrations of zirconium (Zr) and magnesium (Mg) as different metal elements to an acid aqueous solution of cobalt, and mixing the resultant mixture; and precipitating cobalt carbonate (CoCO₃) and simultaneously coprecipitating zirconium and magnesium by adding sodium hydrogen carbonate (NaHCO₃) to the above mixture.

Since various ions are homogeneously mixed in the aqueous solution before adding sodium hydrogen carbonate, zirconium and magnesium are homogeneously dispersed in the obtained precipitation of different metal elements-added cobalt carbonate. Thereafter, this different metal elements-added cobalt carbonate was subjected to a thermal decomposition reaction in the presence of oxygen to obtain different metal elements-added tricobalt tetraoxide as a starting material of cobalt source in which zirconium and magnesium are contained homogeneously by the coprecipitation.

Next, lithium carbonate prepared as a starting material of lithium source and different metal elements-added tricobalt tetraoxide were weighed so that the mixing ratio thereof became a predetermined mixing ratio, and were mixed in a mortar. Thereafter, the resultant mixture was sintered at 850° C. in an air atmosphere for 24 hours to obtain cobalt-based lithium compound oxide to which zirconium and magnesium were added. Thereafter, by grinding this sintered cobalt-based lithium compound oxide to an average particle diameter of 14 μm using a mortar, lithium cobalt compound oxide A and lithium cobalt compound oxide B having a predetermined composition shown in the following Tables 1 to 5 respectively, were obtained.

Further, lithium nickel cobalt manganese oxide having a layered structure was prepared as follows. With respect to the starting material, as a lithium source, lithium carbonate was used and as a nickel-cobalt-manganese source, used was nickel cobalt manganese compound hydroxide (Ni_{0.33}Mn_{0.33}Co_{0.34}(OH)₂ prepared by reacting an aqueous solution of a mixture of nickel sulfate (NiSO₄), cobalt sulfate (CoSO₄, and manganese sulfate (MnSO₄) with an alkali aqueous solution and by coprecipitating them. In this lithium manganese nickel compound oxide, each metal element was dispersed homogeneously.

Then, lithium carbonate prepared as a starting material of the lithium source and nickel cobalt manganese compound hydroxide were weighed so that the mixing ratio became a predetermined ratio and mixed in a mortar. Thereafter, the resultant mixture was sintered in an air atmosphere at 1000° C. for 20 hours to obtain lithium nickel cobalt manganese oxide. By grinding this sintered lithium nickel cobalt manganese oxide to an average particle diameter of 5 μm using a mortar, lithium nickel cobalt manganese oxide represented by a molecular formula: LiNi_{0.33}Mn_{0.33}Co_{0.34}O₂ having a layered structure was obtained.

By weighing and mixing lithium cobalt compound oxide A and lithium cobalt compound oxide B and lithium manganese nickel compound oxide having a layered structure which were obtained as described above and had a predetermined composition respectively so that the mixing ratio thereof became the mixing ratio shown in Table 1 through 5 respectively, a positive electrode active material having a predetermined composition was obtained. Next, this positive electrode active material (to become 94 parts by mass), a carbon powder as a conductant agent (to become 3 parts by mass), and a polyvinylidene fluoride (PVdF) powder as a binder (to become 3 parts by mass) were mixed to prepare the positive electrode mixture and this positive electrode mixture was wet-mixed with an N-methylpyrrolidone (NMP) solution to prepare a slurry.

The slurry was applied to both surfaces of an aluminum-made positive electrode power collecting body having a thickness of 15 μm by a doctor blade method. Thereafter, the positive electrode power collecting body was dried and compressed using a compression roller to a thickness of 150 μm to prepare the positive electrode according to the First to Eleventh Embodiments and First to Tenth Comparative Examples having a short side length of 36.5 mm.

### Preparation of Negative Electrode

95 parts by mass of a graphite powder, 3 parts by mass of carboxymethyl cellulose as a thickener, and 2 parts by mass of a styrene-butadiene rubber (SBR) as a binder were dispersed in water to prepare a slurry. The slurry was applied to both surfaces of a copper-made negative electrode power collecting body having a thickness of 8 μm by a doctor blade method to form an active material mixture layer on both surfaces of the negative electrode power collecting body. Thereafter, the negative electrode power collecting body was dried and compressed using a compression roller to prepare a negative electrode having a short side length of 37.5 mm. The potential of this negative electrode was 0.1 V versus lithium. The active material applying amounts of the active material mixtures of the positive and negative electrodes were controlled such that at the charging voltage (4.4 V in Embodiments) which is a design criterion, the charging capacity ratio at a part where the positive electrode and negative electrodes face each other (negative electrode charging capacity/positive electrode charging capacity) becomes 1.1.

### Preparation of Electrode Body

By winding the positive and negative electrodes that have been prepared as described above and between which a separator composed of a polyethylene-made fine porous film was interposed, in a cylindrical shape and by crushing the resultant electrode body, a flat and spiral-shaped electrode body was prepared.

### Preparation of Electrolyte

In a mixed solvent of EC (20 vol %) and EMC (50 vol %) and DEC (30 vol %), LiPF₆ was dissolved such that the concentration thereof becomes 1 mol/L to prepare a nonaqueous electrolyte and the electrolyte was subjected to the preparation of the battery.

### Preparation of Batteries

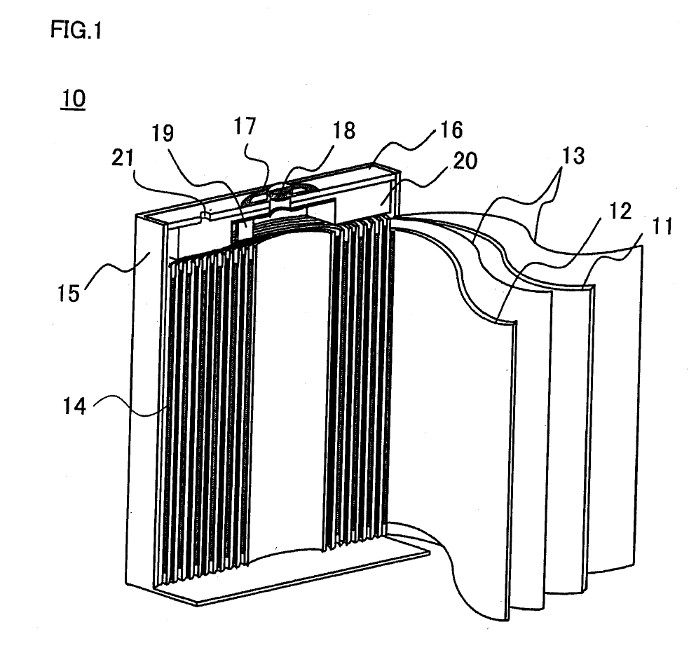

By inserting the electrode body prepared as described above into an outer packing can (5×34×43 mm), by pouring the above electrolyte liquid thereinto and by sealing an opening of the outer packing can, the batteries having the same shape as that shown in FIG. 1 according to the First to Eleventh Embodiments and First to Tenth Comparative Examples were prepared. The designed capacity of the nonaqueous electrolyte secondary batteries produced according to the First to Eleventh Embodiments and First to Tenth Comparative Examples was 850 mAh.

Next, the measuring methods of various battery properties of the nonaqueous electrolyte secondary battery common to the First to Eleventh Embodiments and First to Tenth Comparative Examples, are described.

### Measurement of Initial Discharging Capacity

With respect to each of the batteries prepared as described above according to the First to Eleventh Embodiments and the First to Tenth Comparative Examples, each battery was charged at 25° C. using a constant current of 1 It=850 mA and after the battery voltage reached 4.4 V (the potential of the positive electrode was 4.5 V versus lithium), each battery was initially charged until the charging current value reached 17 mA, while maintaining the battery voltage at 4.4 V. Thereafter, the initially-charged battery was discharged using a constant current of 1 It until the battery voltage reached 3.0 V to measure the discharging capacity at this time as the initial discharging capacity.

### Measurement of Charging/Discharging Cycle Property

With respect to each of the batteries of which initial capacity was measured as described above according to the First to Eleventh Embodiments and First to Tenth Comparative Examples, the charging/discharging cycle property was measured as follows. First, each battery was charged at 25° C. using a constant current of 1 It until the battery voltage reached 4.4 V and after the battery voltage reached 4.4 V, each battery was charged until the charging current value reached 17 mA, while maintaining the battery voltage at 4.4 V Next, at 25° C., the battery was discharged using a constant current 1 It until the battery voltage reached 3.0 V to measure the discharging capacity at this time as a first cycle discharging capacity. Next, such a charging/discharging cycle was repeated 300 times and the discharging capacity of the 300^{th} time was measured as the discharging capacity of the 300^{th} cycle. Then, according to the following calculation equation, the result of the charging/discharging cycle test at 25° C. was calculated as a capacity remaining rate (%).

Capacity remaining rate (%)=(Discharging capacity of 300^{th} cycle/Discharging capacity of first cycle)×100

### Charged Storage Properties

With respect to each of the batteries prepared as described above according to the First to Eleventh Embodiments and First to Tenth Comparative Examples, each battery was charged at 25° C. using a constant current of 1 It and after the battery voltage reached 4.4 V, each battery was charged until the charging current value reached 17 mA, while maintaining the battery voltage at 4.4 V Thereafter, the battery was discharged using a constant current 1 It until the battery voltage reached 3.0 V to measure a discharging capacity at this time as the prepreservation capacity. Thereafter, the battery was charged again using a constant current 1 It and after the battery voltage reached 4.4 V, each battery was charged until the charging current value reached 17 mA, while maintaining the battery voltage at 4.4 V. Then, the battery was stored at 60° C. for 20 days. Thereafter, the battery was discharged using a constant current of 1 It until the voltage reached 3.0 V to measure a discharging capacity at this time as the postpreservation capacity. Then, as an index for the charged storage properties, the capacity remaining rate (%) was calculated according to the following equation:

Capacity remaining rate (%)=(prepreservation capacity/postpreservation capacity)×100

With respect to the results obtained as described above, the results of the First to Third Embodiments and the First and Second Comparative Examples are summarized in Table 1; the results of the Fourth and Fifth Embodiments and the Third and Fourth Comparative Examples are summarized in Table 2; the results of the Sixth and Seventh Embodiments and Fifth and Sixth Comparative Examples are summarized in Table 3; the results of the Eighth and Ninth Embodiments and the Seventh and Eighth Comparative Examples together with the result of the First Embodiment are summarized in Table 4; and the results of the Tenth and Eleventh Embodiments and the Ninth and Tenth Comparative Examples together with the result of the First Embodiment are summarized in Table 5.

TABLE 1

| | | | | | | | | | | 60° C. |
|---|---|---|---|---|---|---|---|---|---|---|
| | | | | | | | Ni—Mn | | | charged |
| | Co compound | | | Co compound | | | compound | | 25° C. | storage (/20 |
| | oxide A | | | oxide B | | | oxide | | cycle test | days) |
| | Zr | Mg | | Zr | Mg | | mixing | Initial | capacity | capacity |
| | (mol | (mol | | (mol | (mol | | ratio (parts | capacity | remaining | remaining |
| | %) | %) | M | %) | %) | M | by mass) | (mAh) | rate (%) | rate (%) |
| Embodiment 1 | 0.01 | 0.5 | 20 | 0.2 | 0.5 | 60 | 20 | 851 | 93 | 78 |
| Embodiment 2 | 0.001 | 0.5 | 20 | 0.2 | 0.5 | 60 | 20 | 852 | 92 | 77 |
| Embodiment 3 | 0.05 | 0.5 | 20 | 0.2 | 0.5 | 60 | 20 | 848 | 91 | 80 |
| Comparative 1 | 0.0007 | 0.5 | 20 | 0.2 | 0.5 | 60 | 20 | 850 | 88 | 70 |
| Comparative 2 | 0.07 | 0.5 | 20 | 0.2 | 0.5 | 60 | 20 | 848 | 80 | 81 |

Charging potential = 4.50 V (versus lithium)
Zr: Zr added amount
Mg: Mg added amount
M: Mixing ratio (parts by mass)

Table 1 shows the results of a case where the added amount of zirconium in lithium cobalt compound oxide A was varied from 0.0007 to 0.01 mol %, while maintaining lithium cobalt compound oxide A:lithium cobalt compound oxide B:nickel manganese compound oxide=20:60:20 (in mass ratio) constant, maintaining the magnesium added amount in lithium cobalt compound oxides A and B at 0.5 mol % constant, and maintaining the zirconium added amount in lithium cobalt compound oxide B at 0.2 mol % constant.

According to the results shown in Table 1, in a case where 20 parts by mass of lithium cobalt compound oxide A in which the zirconium added amount was 0.001 to 0.05 mol % were incorporated, the result of the charging/discharging cycle test was so advantageous as 90% or more and an advantageous result of charged storage properties was also obtained. However, when the zirconium added amount in lithium cobalt compound oxide A was lowered to 0.0007 mol %, the charged storage properties were impaired. A reason for having obtained such a result is considered to be that since the zirconium added amount in lithium cobalt compound oxide A was small, the deterioration of the positive electrode such as the dissolving of cobalt at a high electric potential became remarkable.

On the contrary, when the zirconium added amount in lithium cobalt compound oxide A was elevated to 0.07 mol %, the impairment of the cycle test result was observed. A reason for having obtained such a result is considered to be that since the polarization of lithium cobalt compound oxide A was small, due to the charging/discharging, a load was applied to the negative electrode and the SEI surface coating was deteriorated. Accordingly, from the result shown in FIG. 1, it is confirmed that the optimal zirconium added amount in lithium cobalt compound oxide A is 0.001 to 0.05 mol %.

TABLE 2

| | | | | | | | | | | 60° C. |
|---|---|---|---|---|---|---|---|---|---|---|
| | | | | | | | Ni—Mn | | | charged |
| | Co compound | | | Co compound | | | compound | | 25° C. | storage (/20 |
| | oxide A | | | oxide B | | | oxide | | cycle test | days) |
| | Zr | Mg | | Zr | Mg | | mixing | Initial | capacity | capacity |
| | (mol | (mol | | (mol | (mol | | ratio (parts | capacity | remaining | remaining |
| | %) | %) | M | %) | %) | M | by mass) | (mAh) | rate (%) | rate (%) |
| Embodiment 4 | 0.01 | 0.5 | 20 | 0.1 | 0.5 | 60 | 20 | 850 | 92 | 76 |
| Embodiment 5 | 0.01 | 0.5 | 20 | 1 | 0.5 | 60 | 20 | 848 | 90 | 80 |
| Comparative 3 | 0.01 | 0.5 | 20 | 0.07 | 0.5 | 60 | 20 | 852 | 87 | 63 |
| Comparative 4 | 0.01 | 0.5 | 20 | 1.2 | 0.5 | 60 | 20 | 848 | 75 | 79 |

Charging potential = 4.50 V (versus lithium)
Zr: Zr added amount
Mg: Mg added amount
M: Mixing ratio (parts by mass)

Table 2 shows the results of a case where the added amount of zirconium in lithium cobalt compound oxide B was varied from 0.07 to 1.2 mol %, while maintaining lithium cobalt compound oxide A:lithium cobalt compound oxide B:nickel manganese compound oxide=20:60:20 (in mass ratio) constant, maintaining the magnesium added amount in lithium cobalt compound oxides A and B at 0.5 mol % constant, and maintaining the zirconium added amount in lithium cobalt compound oxide A at 0.01 mol % constant.

According to the results shown in Table 2, with respect to lithium cobalt compound oxide B, when the zirconium added amount was lowered to 0.07 mol %, the charged storage properties were impaired and when the zirconium added amount was elevated to 1.2 mol %, the deterioration of the charging/discharging cycle test result became large and the effect by incorporating lithium cobalt compound oxide A could not be confirmed. Accordingly, from the result shown in FIG. 2, it is confirmed that the optimal zirconium added amount in lithium cobalt compound oxide B is 0.1 to 1 mol %.

TABLE 3

| | | | | | | | | | | 60° C. |
|---|---|---|---|---|---|---|---|---|---|---|
| | | | | | | | Ni—Mn | | | charged |
| | Co compound | | | Co compound | | | compound | | 25° C. | storage (/20 |
| | oxide A | | | oxide B | | | oxide | | cycle test | days) |
| | Zr | Mg | | Zr | Mg | | mixing | Initial | capacity | capacity |
| | (mol | (mol | | (mol | (mol | | ratio (parts | capacity | remaining | remaining |
| | %) | %) | M | %) | %) | M | by mass) | (mAh) | rate (%) | rate (%) |
| Embodiment 6 | 0.01 | 0.5 | 10 | 0.2 | 0.5 | 70 | 20 | 848 | 90 | 80 |
| Embodiment 7 | 0.01 | 0.5 | 30 | 0.2 | 0.5 | 50 | 20 | 850 | 93 | 77 |
| Comparative 5 | 0.01 | 0.5 | 5 | 0.2 | 0.5 | 75 | 20 | 849 | 78 | 80 |
| Comparative 6 | 0.01 | 0.5 | 35 | 0.2 | 0.5 | 45 | 20 | 850 | 92 | 66 |

Charging potential = 4.50 V (versus lithium)
Zr: Zr added amount
Mg: Mg added amount
M: Mixing ratio (parts by mass)

Table 3 shows the results of a case where the mixing ratio in mass ratio of lithium cobalt compound oxide A and lithium cobalt compound oxide B was varied from 5:75 to 35:45, while maintaining (lithium cobalt compound oxide A+lithium cobalt compound oxide B):nickel manganese compound oxide=80:20 (in mass ratio) constant, maintaining the magnesium added amount in lithium cobalt compound oxides A and B at 0.5 mol % constant, maintaining the zirconium added amount in lithium cobalt compound oxide A at 0.01 mol % constant, and maintaining the zirconium added amount in lithium cobalt compound oxide B at 0.2 mol % constant.

According to the results shown in Table 3, it could be confirmed that by setting the mixing ratio in the mass ratio of lithium cobalt compound oxide A and lithium cobalt compound oxide B to the range of 10:70 to 30:50, the compatibility between the charging/discharging cycle test result and the charged storage properties can be contemplated. When the mixing ratio in the mass ratio of lithium cobalt compound oxide A and lithium cobalt compound oxide B became 5:75, though the charged storage properties was advantageous, the charging/discharging cycle test result became impaired. On the contrary, when the mixing ratio in the mass ratio of lithium cobalt compound oxide A and lithium cobalt compound oxide B became 35:45, though the charging/discharging cycle test result was advantageous, the charged storage properties became impaired. Accordingly, from the result shown in FIG. 3, it is confirmed that the optimal mixing ratio in the mass ratio of lithium cobalt compound oxide A and lithium cobalt compound oxide B is in the range of 10:70 to 30:50. This optimal range corresponds to the mass ratio of lithium cobalt compound oxide A relative to the mass of the total positive electrode active material of 10 to 30%.

TABLE 4

| | | | | | | | | | | 60° C. |
|---|---|---|---|---|---|---|---|---|---|---|
| | | | | | | | Ni—Mn | | | charged |
| | Co compound | | | Co compound | | | compound | | 25° C. | storage (/20 |
| | oxide A | | | oxide B | | | oxide | | cycle test | days) |
| | Zr | Mg | | Zr | Mg | | mixing | Initial | capacity | capacity |
| | (mol | (mol | | (mol | (mol | | ratio (parts | capacity | remaining | remaining |
| | %) | %) | M | %) | %) | M | by mass) | (mAh) | rate (%) | rate (%) |
| Embodiment 1 | 0.01 | 0.5 | 20 | 0.2 | 0.5 | 60 | 20 | 851 | 93 | 78 |
| Comparative 7 | 0.01 | 0.007 | 20 | 0.2 | 0.007 | 60 | 20 | 850 | 87 | 72 |
| Embodiment 8 | 0.01 | 0.01 | 20 | 0.2 | 0.01 | 60 | 20 | 852 | 90 | 77 |
| Embodiment 9 | 0.01 | 3 | 20 | 0.2 | 3 | 60 | 20 | 848 | 91 | 78 |
| Comparative 8 | 0.01 | 4 | 20 | 0.2 | 4 | 60 | 20 | 822 | 90 | 79 |

Charging potential = 4.50 V (versus lithium)
Zr: Zr added amount
Mg: Mg added amount
M: Mixing ratio (parts by mass)

Table 4 shows the results of a case where the magnesium added amount in lithium cobalt compound oxides A and B was varied from 0.007 to 4 mol %, while maintaining lithium cobalt compound oxide A:lithium cobalt compound oxide B:nickel manganese compound oxide=20:60:20 (in mass ratio) constant, maintaining the zirconium added amount in lithium cobalt compound oxide A at 0.01 mol % constant, and maintaining the zirconium added amount in lithium cobalt compound oxide B at 0.2 mol % constant.

According to the results shown in Table 4, it could be confirmed that by setting the magnesium added amount in lithium cobalt compound oxides A and B to the range of 0.01 to 3 mol %, the compatibility between the charging/discharging cycle test result and the charged storage properties can be contemplated. When the magnesium added amount in lithium cobalt compound oxides A and B became 0.007 mol %, though the charging/discharging cycle test result was advantageous, the charged storage properties became impaired. On the contrary, when the magnesium added amount in lithium cobalt compound oxides A and B became 4 mol %, the initial capacity was lowered. Accordingly, from the result shown in FIG. 4, it is confirmed that the optimal magnesium added amount in lithium cobalt compound oxides A and B is in the range of 0.01 to 3 mol %.

TABLE 5

| | | | | | | | | | | 60° C. |
|---|---|---|---|---|---|---|---|---|---|---|
| | | | | | | | Ni—Mn | | | charged |
| | Co compound | | | Co compound | | | compound | | 25° C. | storage (/20 |
| | oxide A | | | oxide B | | | oxide | | cycle test | days) |
| | Zr | Mg | | Zr | Mg | | mixing | Initial | capacity | capacity |
| | (mol | (mol | | (mol | (mol | | ratio (parts | capacity | remaining | remaining |
| | %) | %) | M | %) | %) | M | by mass) | (mAh) | rate (%) | rate (%) |
| Embodiment 1 | 0.01 | 0.5 | 20 | 0.2 | 0.5 | 60 | 20 | 851 | 93 | 78 |
| Comparative 9 | 0.01 | 0.5 | 20 | 0.2 | 0.5 | 73 | 7 | 850 | 82 | 78 |
| Embodiment | 0.01 | 0.5 | 20 | 0.2 | 0.5 | 70 | 10 | 853 | 93 | 79 |
| 10 | | | | | | | | | | |
| Embodiment | 0.01 | 0.5 | 20 | 0.2 | 0.5 | 50 | 30 | 847 | 89 | 76 |
| 11 | | | | | | | | | | |
| Comparative | 0.01 | 0.5 | 20 | 0.2 | 0.5 | 45 | 35 | 820 | 88 | 76 |
| 10 | | | | | | | | | | |

Charging potential = 4.50 V (versus lithium)
Zr: Zr added amount
Mg: Mg added amount
M: Mixing ratio (parts by mass)

Table 5 shows the results of a case where the mixing ratio in mass ratio of lithium cobalt compound oxide B and nickel manganese compound oxide was varied from 73:7 to 45:35, while maintaining lithium cobalt compound oxide A:(lithium cobalt compound oxide B+ nickel manganese compound oxide)=20:80 (in mass ratio) constant, maintaining the zirconium added amount in lithium cobalt compound oxide A at 0.01 mol % constant, maintaining the zirconium added amount in lithium cobalt compound oxide B at 0.2 mol % constant, and maintaining the magnesium added amount in lithium cobalt compound oxides A and B at 0.5 mol % constant.

According to the results shown in Table 5, it could be confirmed that by setting the mixing ratio in the mass ratio of lithium cobalt compound oxide B and nickel manganese compound oxide to the range of 70:10 to 50:30, the compatibility between the charging/discharging cycle test result and the charged storage properties can be contemplated. When the mixing ratio in the mass ratio of lithium cobalt compound oxide B and nickel manganese compound oxide became 73:7, though the charged storage properties was advantageous, the charging/discharging cycle test result became impaired. On the contrary, when the mixing ratio in the mass ratio of lithium cobalt compound oxide B and nickel manganese compound oxide became 45:35, though the charging/discharging cycle test result and the charged storage properties were advantageous, the initial capacity was lowered. Accordingly, from the result shown in FIG. 5, it is confirmed that the optimal mixing ratio in the mass ratio of lithium cobalt compound oxide B and nickel manganese compound oxide is in the range of 70:10 to 50:30. This optimal range corresponds to the mass ratio of nickel manganese compound oxide relative to the mass of the total positive electrode active material of 10 to 30%.

What is claimed is:

1. A nonaqueous electrolyte secondary battery comprising:
a positive electrode having a positive electrode active material;
a negative electrode having a negative electrode active material; and
a nonaqueous electrolyte having a nonaqueous solvent and an electrolyte salt;
the positive electrode active material containing lithium cobalt compound oxide in which at least zirconium and magnesium are added, and lithium nickel manganese compound oxide having a layered structure;
the lithium cobalt compound oxide containing at least a mixture of lithium cobalt compound oxide A in which 0.001 to 0.05 mol % of zirconium is added and lithium cobalt compound oxide B in which 0.1 to 1 mol % of zirconium is added, the content of the lithium cobalt compound oxide A being 10 to 30% in a mass ratio based on the total mass of the positive electrode active material;
the magnesium added amount in the lithium cobalt compound oxides A and B being respectively 0.01 to 3 mol %;
the content of the lithium manganese nickel compound oxide having a layered structure being 10 to 30% in a mass ratio based on the total mass of the positive electrode active material; and
the charging potential of the positive electrode active material being more than 4.3 V and 4.6 V or less versus lithium.

2. The nonaqueous electrolyte secondary battery according to claim 1, wherein the charging potential of the positive electrode active material is 4.4 V or more and 4.6 V or less versus lithium.

3. The nonaqueous electrolyte secondary battery according to claim 1, wherein the lithium manganese nickel compound oxide having a layered structure is a compound represented by a formula: LiₐNiₛMnₜCoᵤO₂ (where 0<a≦1.2, 0<s≦0.5, 0<t≦0.5, 0≦u, s+t+u=1, 0.95≦s/t≦1.05).
